(19) United States
(12) Patent Application Publication
(10) Pub. No.: US 2026/0251612 A1
(43) Pub. Date: Aug. 27, 2026

(54) MICROSCALE ELECTROCHEMISTRY ON A PLATE FOR RAPID EVALUATION OF ELECTROCHEMICAL SYSTEMS

(71) Applicant: Wisconsin Alumni Research Foundation, Madison, WI (US)

(72) Inventors: Fang Liu, Madison, WI (US); Andrew Cavell, Madison, WI (US); Tanner Thomas, Madison, WI (US)

(73) Assignee: Wisconsin Alumni Research Foundation, Madison, WI (US)

(21) Appl. No.: 19/545,914

(22) Filed: Feb. 20, 2026

Related U.S. Application Data
(60) Provisional application No. 63/763,715, filed on Feb. 26, 2025.

(51) Int. Cl. G01N 27/416; G01N 27/30; G01N 27/42

(52) U.S. Cl. CPC G01N 27/4166; G01N 27/301; G01N 27/423

(57) ABSTRACT

Methods and systems for the rapid, high-throughput evaluation of electrolyte solutions in electrochemical cells are provided. The methods and systems use rapid transient cyclic voltammetry with ultra-microelectrodes (UMEs) to accurately predict the Coulombic efficiencies of microelectrochemical cells containing very small volumes of electrolyte solutions.

### CROSS-REFERENCE TO RELATED APPLICATIONS

The present application claims priority to U.S. provisional patent application No. 63/763,715 that was filed on Feb. 26, 2025, the entire contents of which are hereby incorporated by reference.

### BACKGROUND

To drive the rapid development and deployment of critical energy technologies, processes for the design, and evaluation of new energy, systems must be fundamentally accelerated and transformed. This is especially crucial for electrochemical systems, which are needed for the decarbonization of transportation and the power grid—a critical energy challenge facing society. Electrolyte solutions within these electrochemical systems play a critical role in determining interfacial electrochemical behaviors and overall electrochemical performance, such as cycle lifetime, calendar life, working temperature, and rate capability. However, existing electrolyte design and testing methods are complex, slow, and costly, creating a significant bottleneck that impedes swift innovation and technological advancement.

One parameter that is commonly used to evaluate electrochemical cells, such as batteries, is Coulombic efficiency (CE), which is a measure of how much capacity the cell loses during each charge/discharge cycle. CE is a useful predictor of the potential lifetime of an electrochemical cell. However, conventional CE measurements are typically conducted over hundreds or thousands of charge/discharge cycles for each electrochemical cell being tested. As a result, conventional CE testing is a low-throughput and time-consuming process.

### SUMMARY

Methods and systems for the rapid and high-throughput evaluation of sample electrolyte solutions in electrochemical cells based on precise and ultrafast transient cycle voltammetry (CV) measurements are provided. The exchange current densities (j₀) calculated from the precise transient CV measurements can be correlated with CEs, which provide an assessment of an electrochemical cell's long-term stability and performance.

Methods and systems for the evaluation of liquid electrolyte solutions in electrochemical cells are provided.

One embodiment of a method for evaluating liquid electrolytes is carried out in a microelectrochemical cell array that includes a plurality of sample microelectrochemical cells, each sample microelectrochemical cell comprising: a well containing a sample liquid electrolyte solution, wherein the sample liquid electrolyte solutions are different in different sample microelectrochemical cells, and further wherein the sample liquid electrolyte solution has a volume of no greater than 200 μL, including embodiments in the sample liquid electrolyte solution has a volume of no greater than 100 μL; an ultramicro-working electrode in the sample liquid electrolyte solution; a counter electrode in the sample liquid electrolyte solution; and, optionally, a reference electrode in the sample liquid electrolyte solution. The method includes the steps of: generating one or more transient cyclic voltammograms for each sample microelectrochemical cell under conditions in which electrochemical reactions at the ultramicro-working electrode are kinetically controlled; calculating an exchange current density (j₀) for each sample microelectrochemical cell based on the one or more transient cyclic voltammograms for said sample microelectrochemical cell; providing a linear regression model for a plot of j₀ function values obtained from a set of standard microelectrochemical cells versus Coulombic efficiency (CE) values obtained from a set of corresponding standard electrochemical cells; and estimating the CE for each sample microelectrochemical cell based on a comparison of its calculated exchange current density with the linear regression model.

One embodiment of a system for evaluating liquid electrolytes includes: a microelectrochemical cell array comprising a plurality of microelectrochemical cells, each microelectrochemical cell comprising: a well for containing a sample liquid electrolyte solution; an ultramicro-working electrode in the well; and a counter electrode in the well. The system further includes: one or more potentiostats connected to the ultramicro-working electrode in each cell; and a computing system. The computing system includes: a memory having computer-readable instructions stored thereon; and a processor that executes the computer-readable instructions to: receive a linear regression model for a plot of j₀ function values obtained from a set of standard microelectrochemical cells versus Coulombic efficiency (CE) values obtained from a set of corresponding standard electrochemical cells; receive applied potential versus current density data generated by the one or more potentiostats; generate transient cyclic voltammograms for the plurality of microelectrochemical cells based on the applied potential versus current density data; calculate exchange current density (j₀) values for the plurality of microelectrochemical cells from the transient cyclic voltammograms; estimate a CE for each of the microelectrochemical cells based on a comparison of its calculated exchange current density value with the linear regression model.

Other principal features and advantages of the invention will become apparent to those skilled in the art upon review of the following drawings, the detailed description, and the appended claims.

### BRIEF DESCRIPTION OF THE DRAWINGS

Illustrative embodiments of the invention will hereafter be described with reference to the accompanying drawings, wherein like numerals denote like elements.

FIG. 1A. Schematic illustration of one microelectrochemical cell of a microelectrochemical cell array integrated with an array substrate.

FIG. 1B. Schematic illustration of an array of microelectrochemical cells of the type shown in FIG. 1A integrated into an array substrate with electronic traces for connecting the microelectrochemical cells in external circuits.

FIG. 1C. Illustrative dimensions for one microelectrochemical cell in the array of FIG. 1B.

FIG. 1D. Schematic illustration of the array of microelectrochemical cells of FIG. 1B, having silicon dioxide-coated metal traces, leaving only the electrode faces exposed to the electrolyte solution. The inset at the lower right shows and enlarged view of a single microelectrochemical cell.

FIG. 2. Generic ln(j₀) versus CE scatter plot with a line fit using a linear regression.

FIG. 3. A flow diagram of a method for estimating the CE value of a sample electrochemical cell.

FIG. 4. An example of the computing system that can be used to carry out steps in a method for estimating CE values.

FIG. 5A. Transient CV curves (comparative) obtained using a beaker cell, as described in the Examples.

FIG. 5B. Transient CV curves (comparative) obtained using a microelectrochemical cell, as described in the Examples, illustrating the improved data consistency realized using the microelectrochemical cell.

FIG. 6A. Graph of ln(j₀) versus CE data (dots) obtained for a beaker cell with a 50 μm copper working electrode, a lithium (Li) counter electrode, and a lithium (Li) reference electrode, as described in the Examples. The fitted line demonstrates the linear relationship between CE and ln(j₀).

FIG. 6B. Graph of ln(j₀) versus CE data (dots) obtained for a beaker cell with a 50 μm copper working electrode, a sodium (Na) counter electrode, and a sodium (Na) reference electrode, as described in the Examples. The fitted line demonstrates the linear relationship between CE and ln(j₀).

FIG. 6C. Graph of ln(ln j₀) versus CE data (dots) obtained for the beaker cell with a 50 μm copper working electrode, a lithium (Li) counter electrode, and a lithium (Li) reference electrode, as described in the Examples. The fitted line demonstrates the linear relationship between CE and ln(ln j₀).

FIG. 6D. Graph of ln(ln j₀) versus CE data (dots) obtained for the beaker cell with a 50 μm copper working electrode, a sodium (Na) counter electrode, and a sodium (Na) reference electrode, as described in the Examples. The fitted line demonstrates the linear relationship between CE and ln(ln j₀).

FIG. 6E. Graph of j₀ versus CE data (dots) obtained for the beaker cell with a 50 μm copper working electrode, a lithium (Li) counter electrode, and a lithium (Li) reference electrode, as described in the Examples. The fitted linear segments demonstrate a piecewise linear relationship between CE and j₀.

FIG. 6F. Graph of j₀ versus CE data (dots) obtained for the beaker cell with a 50 μm copper working electrode, a sodium (Na) counter electrode, and a sodium (Na) reference electrode, as described in the Examples. The fitted linear segments demonstrate a piecewise linear relationship between CE and j₀.

FIG. 6G. Graph of ln(ln j₀) versus CE data (dots) obtained for a microelectrochemical cell with four different electrolyte solutions, using a copper UME working electrode, a sodium (Na) counter electrode, and a sodium (Na) reference electrode, as described in the Examples. The fitted line demonstrates the linear relationship between CE and ln(ln j₀).

FIG. 7A. A representative transient CV curve for a microelectrochemical cell.

FIG. 7B. Kinetically controlled region of the CV curve before iR correction.

FIG. 7C. Kinetically controlled region of the CV curve after iR correction.

FIG. 7D. Linear fitting to the kinetically controlled region of the CV curve at the low overpotential region.

### DETAILED DESCRIPTION

Methods and systems for the rapid evaluation of electrolyte solutions in electrochemical cells are provided. The methods and systems use rapid transient CV with ultra-microelectrodes (UMEs) to accurately predict the CE of microelectrochemical cells containing very small volumes of electrolyte solutions. The methods can be carried out quickly—in a matter of seconds—with high throughput and are based on a universal approach that can be applied across diverse electrochemical systems. The methods provide an attractive alternative to conventional direct CE measurements, which can take hours or even weeks. As such, the methods and systems can accelerate the discovery of new and useful electrolyte solutions having robust and predictable electrochemical properties.

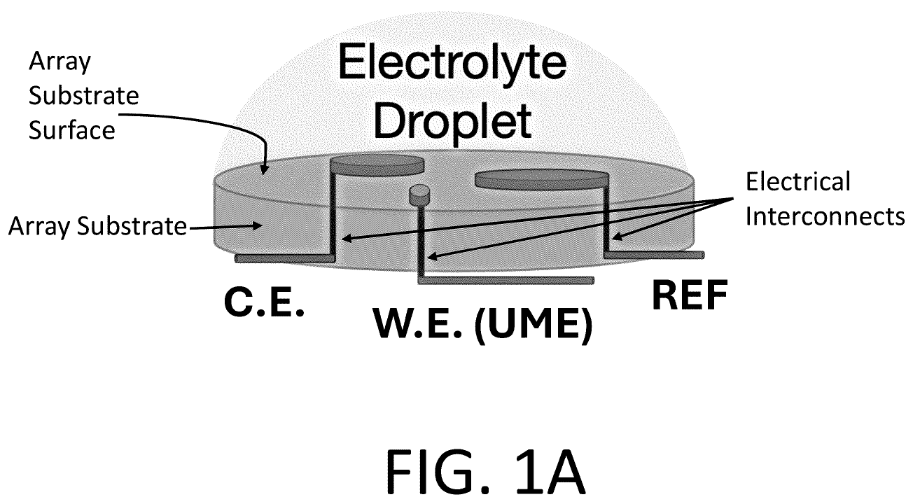

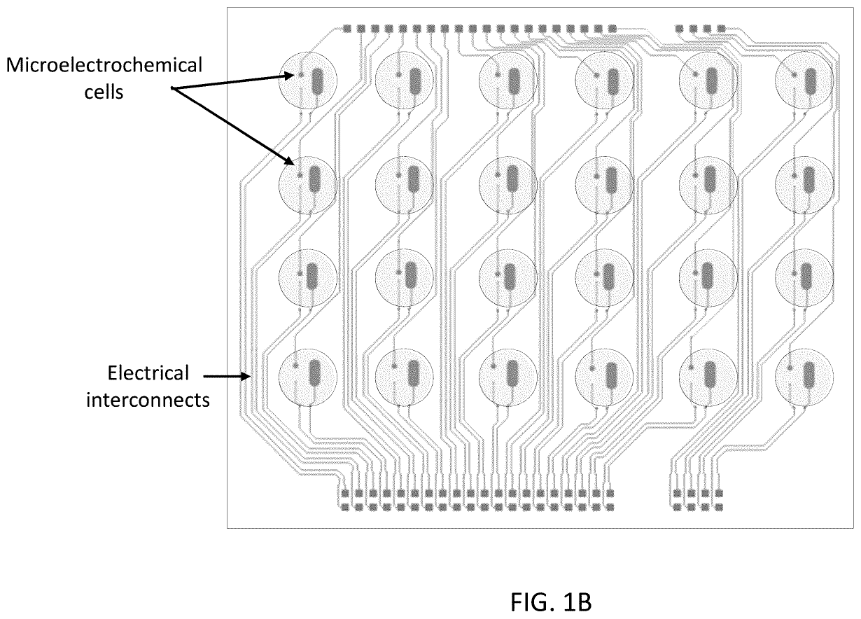

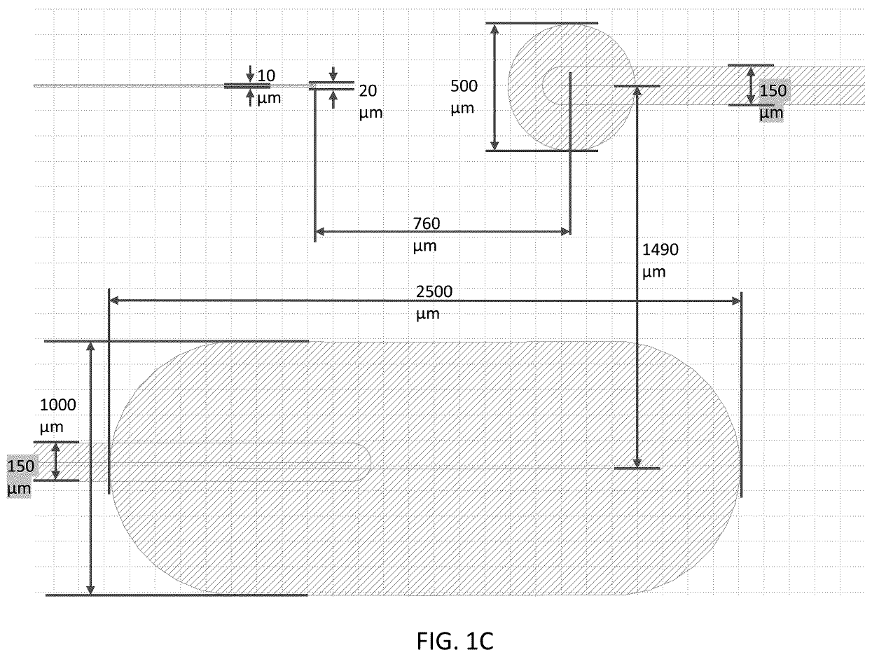

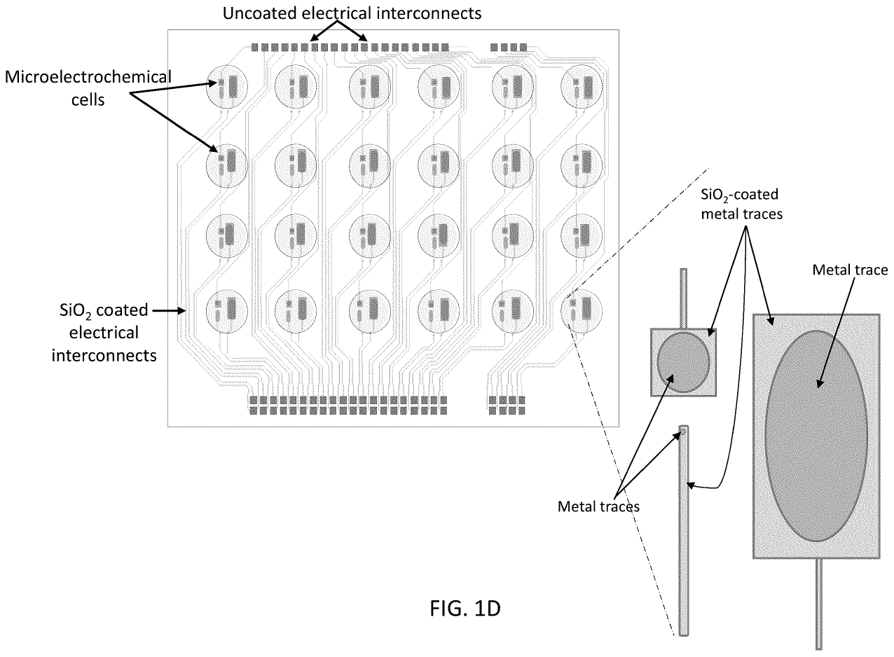

The methods and systems use a microelectrochemical cell array to conduct transient CV on multiple microelectrochemical cells simultaneously or in rapid succession. The microelectrochemical cell array includes a plurality (i.e., two or more) of microelectrochemical cells, each cell comprising a well for containing a sample liquid electrolyte solution, a working electrode (W.E.) in the well, and a counter electrode (C.E.) in the well, as illustrated schematically in FIG. 1A. The microelectrochemical cells may also, optionally, include a reference electrode (REF) in the well. The microelectrochemical cells are so-called because they are dimensioned to hold very small volumes of the liquid electrolytes—in the range of microliters (μL).

The working electrodes of the microelectrochemical cells are UMEs and are, therefore, referred to as ultramicro-working electrodes. UMEs are characterized by at least one microscale dimension and a surface area smaller than that of the diffusion layer formed during the electrochemical reaction at the working electrode. Generally, electrodes having at least one lateral dimension that is no larger than 25 μm can act as a UME, where the lateral dimension for a circular UME corresponds to its diameter and the lateral dimension for a UME having a polygon shape corresponds to a largest width dimension (e.g., a corner-to-corner dimension for a square shape). This includes electrodes having at least one lateral dimension no larger than 10 μm. The small size and surface area of a UME facilitates very fast mass transport rates and enables electrochemical reactions carried out at a working UME to take place under kinetic control, rather than mass transport control.

The ultramicro-working electrodes can be fabricated using lithographic techniques, such as photolithography, and metal evaporation. This produces electrodes with low surface roughness, uniform surface morphology and composition, and consistent surface chemistry. As a result, the transient CV measurements obtained using the ultramicro-working electrodes are highly consistent. In contrast, conventional UMEs, which typically consist of a metal wire embedded in glass, must undergo extensive mechanical polishing and chemical cleaning after each testing, which leads to significant variations in their surface roughness and chemical compositions and poor data consistency.

The combination of small microelectrochemical cell dimensions and high-quality UME working electrodes facilitates measurements of the kinetics of electrochemical reactions under kinetic control, while mitigating the data inconsistencies that are typical of measurements made using UME in larger cells, such as beaker cells. This results in highly consistent transient CV measurements. From these highly consistent transient CV measurements, precise exchange current densities can be calculated for the working electrode reactions and used to predict the CE of the microelectrochemical cells.

The methods and systems described herein are based, at least in part, on the ability to obtain exchange current densities, j₀s, with high precision and the revelation that there are strong predictive linear correlations between CE and j₀. Taking advantage of these predictive correlations, a linear regression fit to a plot of some function of (j₀) versus CE for a set of standard microelectrochemical cells (SMCs) can be used for the rapid and accurate prediction of the CEs for one or more sample microelectrochemical cells (sample MCs) based on rapid transient CV. By way of illustration, the plot that is fit via a linear regression model may be a plot of j₀ (i.e., the trivial function j₀-j₀) versus CE data for the SMCs, a plot of ln(j₀) versus CE data for the SMCs or a plot of ln(ln j₀) versus CE for the SMCs. The linear regression model used to fit the data may be a simple linear regression model (i.e., a single linear relationship used to model all of the data) or a piecewise linear regression model (i.e., two or more linear relationships used to model the data). As illustrated in the Examples, linear regression fits having coefficients of determination (R²) of 0.7 or higher, including R² values of at least 0.8, at least 0.9, at least 0.95, and at least 0.99 can be achieved for these functions. In the case of a piecewise linear regression, these R² ranges apply to each linear segment in the fit.

Before the performance of a sample MC can be evaluated, the linear regression fit to the j₀ function versus CE data for the set of SMCs is obtained. The SMCs have the same microelectrochemical cell design, geometry, and dimensions, including the same types of UME working electrodes, counter electrodes, and, if present, reference electrodes. However, different microelectrochemical cells in the set of SMCs include well-defined, but different, “standard” electrolyte solutions.

To obtain j₀ data for the SMCs, fast transient CV measurements are obtained using the UME working electrodes to probe the electron transfer kinetics at the electrode interface under conditions of kinetic control with excellent data consistency. Transient cyclic voltammograms are obtained by scanning a potential applied to the working electrode, at a given scan rate and within a potential window, through a forward scan and a reverse scan and measuring the current per unit area (current density) passed. For consistency, any conditions that would affect the transient CV measurements, such as temperature, should be the same for all the transient CV measurements. The temperature and other conditions under which the data is obtained may be selected based on the temperature and other conditions under which the electrochemical cell is expected to operate.

For each SMC, one or more transient cyclic voltammograms are obtained. For each SMC, a corresponding CE is obtained for a corresponding standard electrochemical cell (CSEC) having the same cell design as said SMC, including the same electrode materials and electrolyte solution. However, the CSECs used to measure CE values may be significantly larger than the SMC and may be of a common electrochemical cell type, such as a coin cell or a pouch cell. The CE measurements obtained using the CSECs can be based on known methods, such as Aurbach's testing method. A description of Aurbach's method and other known methods for CE measurements can be found in Adams, Brian D., et al. “Accurate determination of coulombic efficiency for lithium metal anodes and lithium metal batteries.” Advanced Energy Materials 8.7 (2018): 1702097. If more than one transient CV curve is obtained, the multiple transient CV curves can be averaged. However, because the microelectrochemical cells described herein can be used to produce transient CV curves with such high precision, it is not necessary to obtain more than one. The transient CV measurements can be carried out rapidly. For example, a transient CV curve can be generated in less than 2 seconds and even in less than 1 second.

For purposes of clarification, if only some (micro) electrochemical cells in a plurality of available (micro) electrochemical cells are being used to generate a linear regression model from a set of standard electrolyte solutions, or if only some microelectrochemical cells in a plurality of available microelectrochemical cells are being used to evaluate the CE of a set of sample electrolyte solutions, it is only those (micro) electrochemical cells that are in use that constitute the array of SMCs and the array of sample MCs.

Exchange current density, which is the magnitude of the partial anodic and cathodic current densities of an electrochemical cell at equilibrium, is a measure of electron-transfer activity at the surface of an electrode at an equilibrium potential. The exchange current density, j₀, for a MC can be calculated from the transient cyclic voltammograms by fitting the linear portion of the CV curves (i.e., the kinetically controlled region) near the equilibrium potential for the charge and discharge cycles (e.g., metal plating and stripping cycles). A more detailed description of this method for calculating j₀ using a linear fit to a portion of a transient CV curve is provided in the Examples.

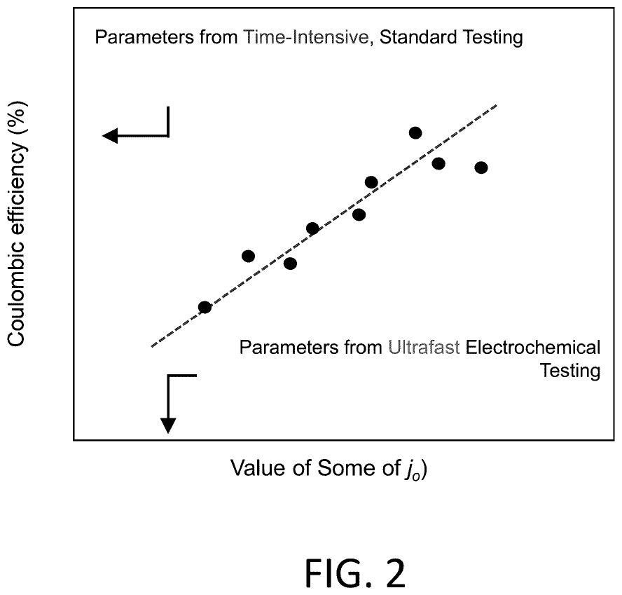

A given function of the (j₀) data is then plotted against the CE data for the set of SMCs and that plot is then fit using a linear regression to provide a linear equation that models the data. The j₀ data can be presented as different functions of j₀ to obtain a linear fit. For example, the j₀ functions may be a ln(j₀) function or a ln(ln j₀) function to produce a linear fit. A generic linear regression fit to a function of j₀ versus CE data for a set of SMCs is shown in FIG. 2. A high-quality linear regression fit can generally be achieved using a relatively small number (e.g., 5-10) SMCs. For example, the fit may be based on CE and j₀ data from ten SMCs. In some embodiments, the fit is based on CE and j₀ data from 20 or fewer SMCs, 30 or fewer SMCs, or 50 or fewer SMCs. However, the fit may be based on CE and j₀ data from a greater number of SMCs.

Once a linear regression model has been generated for a set of SMCs, it can be used to rapidly predict the CEs for one or more sample MCs based on transient CV measurements carried out on said sample MCs. The transient CV measurements can be carried out rapidly on a large number of sample MCs and those measurements can be converted into exchange current densities, as described above. The j₀ values for the sample MCs obtained in this manner can be correlated accurately to CEs based on a comparison with the linear regression model obtained for the SMCs.

The sample MCs have the same electrochemical cell design, geometry, and dimensions, including the same types of UME working electrodes, counter electrodes, and, if present, reference electrodes, as the SMEs-differing only in their electrolyte solutions. The SMEs and sample MEs having the same electrochemical cell design, geometry, and dimensions are referred to as corresponding standard and sample microelectrochemical cells. For consistency, any conditions that would affect the transient CV measurements, such as temperature, should be the same for all the transient CV measurements. The temperature and other conditions under which the data is obtained may be selected based on the temperature and other conditions under which the electrochemical cell is expected to operate.

The same microelectrochemical cell array may be used to assemble and test the sample MEs and the SMEs; however, separate arrays can also be used. Transient CV of the SMCs and sample MCs can be conducted simultaneously or in sequence.

To provide a compact microelectrochemical cell array, the microelectrochemical cells can be integrated into an array substrate, as illustrated in the schematic diagram of FIG. 1A. In the integrated microelectrochemical cell shown in side-view in FIG. 1A, the wells are disposed on a surface of the array substrate, the working electrode (W.E.), counter electrode (C.E.), and, optionally, reference electrode (REF) are deposited on or set into the array substrate surface, and the electrical interconnects to the electrodes pass through the array substrate. (In order to visualize the liquid electrolyte and electrodes, the walls of the well, which would encircle the liquid electrolyte, are not shown in FIG. 1A. FIG. 1B shows a top view of an array of microelectrochemical cells with electrical traces connected to the electrodes for connecting the electrodes to an external circuit. Illustrative microelectrochemical cell dimensions, including illustrative dimensions for the UME working electrode, the counter electrode, and the reference electrode are shown in FIG. 1C. As shown in FIG. 1D, the electrically conducting (e.g., metal) traces of an array can be coated with a dielectric material, such as SiO₂, so that only the electrodes are exposed to the electrolyte solution in the wells through the coating.

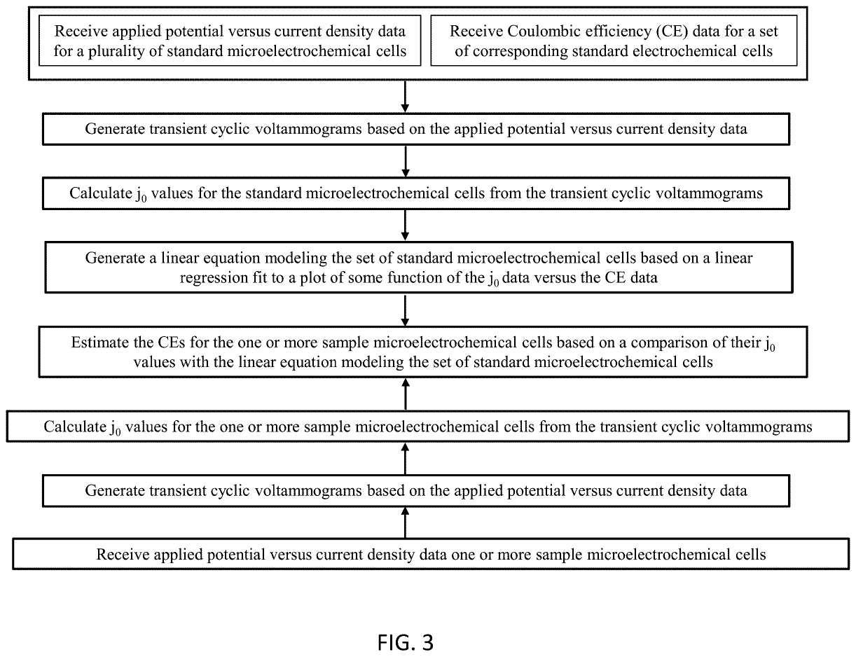

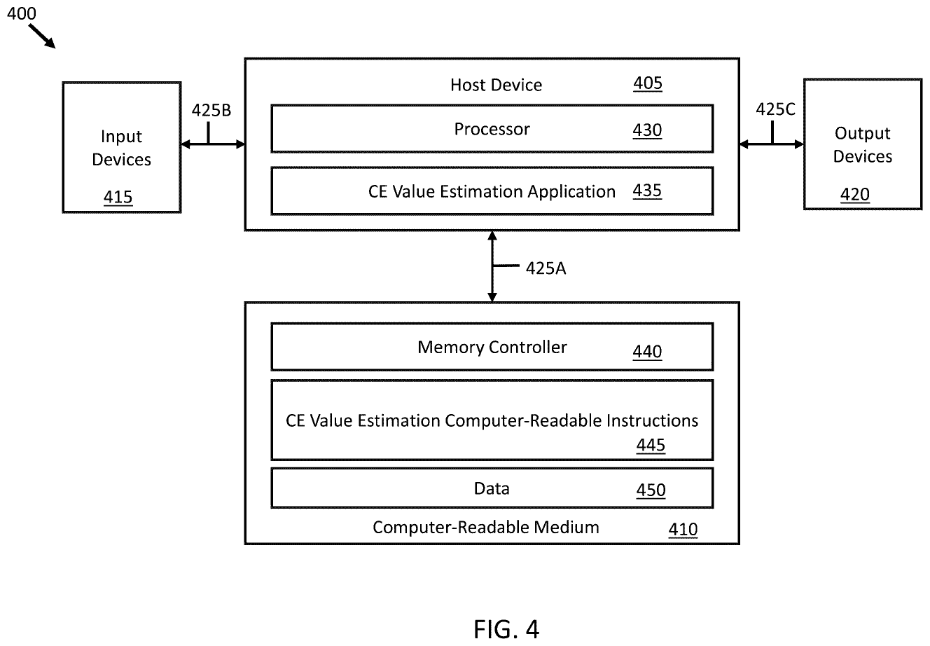

The transient CV curves can be obtained using a potentiostat connected to the working electrode in a microelectrochemical cell. The potentiostat can be controlled by potentiostat software that allows a user to select experimental parameters, such as the potential window, scan rate, and number of scans. (This software may be integrated into a larger computing system, of a type described below in conjunction with FIGS. 3 and 4.) A multiplexer can be used with the potentiostats to increase the number of controllable MC. Systems for carrying out transient CV measurements are available. These systems include integrated software for plotting and displaying transient CV curves based on current-voltage data received from a potentiostat and may also include an electrolyte solution handling robot to automate the filling the wells in the microelectrochemical cells. One such system is described in Oh, Inkyu, et al. “The Electrolab: An open-source, modular platform for automated characterization of redox-active electrolytes.” Device 1.5 (2023). However, the size and geometry of the electrochemical cells described by Oh, Inkyu, et al. would need to be reduced and modified as microelectrochemical cells of the type described herein.

The sample wells containing the standard electrolyte solutions and the sample electrolyte solutions are characterized by small interior dimensions and volumes. The volume of electrolyte solution contained within the well of a microelectrochemical cell is typically no greater than 100 μL. However, the interior volume of the well may be larger, since the well need not be completely filled with the liquid electrolyte solution. By way of illustration only, wells having lateral dimensions of no greater than about 6 mm and/or interior volumes of no greater than about 0.5 mL can be used.

The volume of liquid electrolyte solution (an “electrolyte droplet”) in a well of an microelectrochemical cell is small but sufficient to cover the electrodes in the well. By way of illustration, the microelectrochemical cells may have dimensions such that a volume of electrolyte solution having a volume of 100 μL or less, 50 μL or less, 20 μL or less, or 10 μL or less covers the electrodes. For example, in some embodiments of the methods and systems described herein, the volume of the electrolyte solution contained in the wells of the microelectrochemical cells is in the range from 1 μL to 100 μL, including embodiments in which the volume of the electrolyte solution contained in the wells of the microelectrochemical cells is in the range from 5 μL to 20 μL.

The microelectrochemical cell arrays include at least two microelectrochemical cells but desirably include many more to facilitate the high-throughput screening of many sample electrolyte solutions. By way of illustration, a microelectrochemical cell array may include at least ten microelectrochemical cells, at least 50 microelectrochemical cells, or at least 100 microelectrochemical cells. For example, a microelectrochemical cell array may have 10 to 1000 microelectrochemical cells. The microelectrochemical cells of an array may be disposed on a common array substrate comprising a dielectric material, such as a glass substrate.

The methods described herein for estimating the CE values for sample MCs based on rapid transient CV measurements can be performed by a system that includes the microelectrochemical cell arrays, one or more potentiostats for scanning an applied potential to the working electrodes and measuring current density, and, optionally, one or more multiplexers connected to the one or more potentiostats to increase the number of controllable potentiostat channels. These components of the system can be interfaced with a computing system configured to carry out some of the method steps.

A flow diagram showing the steps carried out by a processor (e.g., associated with an application) executing computer-readable instructions stored on a computer-readable medium is provided in FIG. 3. The processor may be part of or associated with a computing system. An example of the computing system is shown in FIG. 4. As shown in FIG. 3, the processor is configured to: receive applied potential versus current density data generated by the one or more potentiostats that are connected to a plurality of SMCs in the array; receive CE data for a set of CSECs; generate transient cyclic voltammograms for the plurality of SMCs based on the applied potential versus current density data; calculate j₀ values for the SMCs from the transient cyclic voltammograms; generate a linear equation modeling the set of SMCs based on a linear regression fit to a plot of a j₀ function versus the CE data for the SMCs; estimate the CEs for one or more sample MCs based on the values of the j₀ function for said one or more sample MCs and the linear equation modeling of the set of SMCs; and, optionally, outputting an estimate of the CEs for the one or more sample MCs. More details regarding the computing system are described below in conjunction with FIG. 4. The function of j₀ may be, for example, a natural log function, such as ln(j₀) or ln(ln j₀).

The methods and systems described herein are not limited to use with any specific types of electrochemical cells. More details regarding components that are common to many types of electrochemical cells are provided below. The materials and details provided below are not intended to be exhaustive.

The working electrode in a microelectrochemical cell performs an electrochemical reaction of interest and, therefore, the material from which the working electrode is made will depend on said reaction. Examples of working electrodes that can be used include metal or metal-containing electrodes, including those that are used in metal ion batteries. The working electrode may include a current collector upon which an active material is disposed. Current collectors are composed of electrically conductive materials, typically metals, such as copper or aluminum, but non-metals, such as carbon, can be used. Active materials for working electrodes may comprise or consist of alkali metals, such as lithium, sodium, and potassium; alkaline earth metals, such as magnesium; transition metals, such as iron, copper, and zinc; and post-transition metals, such as aluminum and tin. Metal oxides can also be used. Working electrodes comprising or consisting of non-metals, including carbon, include graphite, silicon, non-metal oxides, sulfur and polyanions, and gas (e.g., O₂, CO₂, and N₂).

The counter electrode in a microelectrochemical cell is connected to the working electrode such that it completes an electrical circuit and is not a UME. In fact, the counter electrode will be significantly larger than a UME. When a potential is applied to the working electrode to induce an electrochemical reaction at said electrode, electrons flow between the working electrode and the counter electrode. Like the working electrode, the counter electrode may include a current collector upon which an active material is deposited. A wide range of materials can be used as counter electrodes, including metals, such as Li and Na. However, to avoid the reactions at the counter electrode from interfering with the kinetics of the reactions at the working electrode, it may be desirable for the counter electrode to be composed of an inert material that generates few or no by-products during the operation of the electrochemical cell. Non-limiting examples of counter electrodes that can be used include electrodes comprising or consisting of platinum or carbon. The electrons at the counter electrode can carry out a variety of electrochemical reactions. For example, if the working electrode is acting as an anode carrying out a reduction reaction, the counter electrode can act as a cathode carrying out an oxidation reaction. In a microelectrochemical cell that is being used to evaluate an electrolyte solution for a metal ion battery, the counter electrode may comprise or consist of a material that acts as a reservoir for metal ions during charge/discharge cycling of the cell. Such materials include metal salts.

Optionally, a reference electrode can be included in the microelectrochemical cell circuit to provide a more accurate measurement of the potential applied to the working electrode relative to a reference reaction having a stable and well-defined equilibrium potential. The reference electrode is composed of a material that exhibits a reversible, stable, and reproducible potential under the conditions in which the transient CV measurements are carried out. The selection of a reference electrode for a given microelectrochemical cell will be based, at least in part, on the electrochemical reaction being carried out at the working electrode and the chemical composition of the electrolyte solution. By way of illustration, reference electrodes that are commonly used in metal ion batteries include metal oxide intercalation compounds and metal alloys. For example, reference electrodes in lithium batteries include Li, LiFePO₄ (LFP), Li₄Ti₅O₁₂ (LTO), LiSn, LiAl, and LiAu. However, other reference electrodes can be used. Common widely used reference electrodes include silver/silver chloride (Ag/AgCl) electrodes and saturated calomel electrodes (SCEs).

The electrolyte solutions in the sample MCs (referred to as “sample electrolyte solutions”) are formulated based on the intended application for the cells. “Different” electrolyte solutions differ in at least one aspect of their chemical composition. For example, the electrolyte solutions may include different chemical components and/or different concentrations of chemical components.

The electrolyte solutions include salts that provide ions (cations and anions) dissolved in a solvent or solvent mixture. The ions include cations and/or anions that undergo electrochemical reactions at an electrode, generally referred to as electrolytes, and may also include ions that increase the conductivity of the electrolyte solution and/or maintain solution neutrality, but that are electrochemically inert within the range of potentials used to carry out the electrochemical reactions, generally referred to as supporting electrolytes. For example, in metal ion batteries, the analytes are typically metal ions that are transferred between the working and counter electrodes. The metal ions in an electrolyte solution are generally provided in the form of metal salts, including salts of the metals described above. Non-limiting examples of metal salts include metal sulfates, metal nitrates, metal acetates, metal halides, metal hexafluorophosphates, and metal perchlorates. However, a wide range of other types of salts may be used, including ammonium salts.

In addition to the salts discussed above, various other chemical species may be included as additives in the electrolyte solutions to improve or alter the performance of an electrochemical cell. These additives include both organic and inorganic compounds. Additives may carry out a variety of functions including, but not limited to, reducing the occurrence of unwanted chemical or electrochemical side-reactions in the electrolyte solution and/or stabilizing an electrode/electrolyte solution interface.

The solvents in the electrolyte solutions may be aqueous or non-aqueous organic solvents and will be selected based, at least in part, on the solubility of the electrolytes therein. Non-limiting examples of organic solvents include alkyl carbonates, such as ethylene carbonate, diethyl carbonate, and dimethyl carbonate, N,N-dimethylformamide, dichloromethane, and tetrahydrofuran.

Turning now to FIG. 4, a block diagram of an example computing system 400 is shown, in accordance with some embodiments of the present disclosure. The computing system 400 includes a host device 405 associated with a computer-readable medium 410. The host device 405 may be configured to receive input from one or more input devices 415 and provide output to one or more output devices 420. The host device 405 may be configured to communicate with the computer-readable medium 410, the input devices 415, and the output devices 420 via appropriate communication interfaces, buses, or channels 425A, 425B, and 425C, respectively. The computing system 400 may be implemented in a variety of computing devices such as computers (e.g., desktop, laptop, etc.), servers, tablets, personal digital assistants, mobile devices, wearable computing devices such as smart watches, other handheld or portable devices, or any other computing units suitable for performing operations described herein using the host device 405.

Further, some or all of the features described in the present disclosure may be implemented on a client device, an on-premise server device, a cloud/distributed computing environment, or a combination thereof. Additionally, unless otherwise indicated, functions described herein as being performed by a computing device (e.g., the computing system 400) may be implemented by multiple computing devices in a distributed environment, and vice versa.

The input devices 415 may include any of a variety of input technologies such as a keyboard, stylus, touch screen, mouse, track ball, keypad, microphone, voice recognition, motion recognition, remote controllers, input ports, one or more buttons, dials, joysticks, point of sale/service devices, card readers, chip readers, and any other input peripheral that is associated with the host device 405 and that allows an external source, such as a user, to enter information (e.g., data) into the host device 405 and send instructions to the host device 405. Similarly, the output devices 420 may include a variety of output technologies such as external memories, printers, speakers, displays, microphones, light emitting diodes, headphones, plotters, speech generating devices, video devices, and any other output peripherals that are configured to receive information (e.g., data) from the host device 405. The “data” that is either input into the host device 405 and/or output from the host device 405 may include any of a variety of textual data, numerical data, alphanumerical data, graphical data, video data, sound data, position data, combinations thereof, or other types of analog and/or digital data that is suitable for processing using the computing system 400.

The host device 405 may include a processor 430 that may be configured to execute instructions for running one or more applications associated with the host device 405. In some embodiments, the instructions and data needed to run the one or more applications may be stored within the computer-readable medium 410. The host device 405 may also be configured to store the results of running the one or more applications within the computer-readable medium 410. One such application on the host device 405 may be a CE Value Estimation application 435. The CE Value Estimation application 435 may be used to provide an estimated CE value for one or more microelectrochemical cells based on applied potential versus current density data received from said one or more microelectrochemical cells.

The CE Value Estimation application 435 may be executed by the processor 430. The instructions to execute the CE Value Estimation application 435 may be stored within the computer-readable medium 410. To facilitate communication between the host device 405 and the computer-readable medium 410, the computer-readable medium 410 may include or be associated with a memory controller 440. Although the memory controller 440 is shown as being part of the computer-readable medium 410, in some embodiments, the memory controller 440 may instead be part of the host device 405 or another element of the computing system 400 and operatively associated with the computer-readable medium 410. The memory controller 440 may be configured as a logical block or circuitry that receives instructions from the host device 405 and performs operations in accordance with those instructions. For example, to execute the CE Value Estimation application 435, the host device 405 may send a request to the memory controller 440. The memory controller 440 may read the instructions associated with the CE Value Estimation application 435. For example, the memory controller 440 may read CE Value Estimation computer-readable instructions 445 stored within the computer-readable medium 410 and send those instructions back to the host device 405. In some embodiments, those instructions may be temporarily stored within a memory on the host device 405. The processor 430 may then execute those instructions by performing one or more operations called for by those instructions.

The computer-readable medium 410 may include one or more memory circuits. The memory circuits may be any of a variety of memory types, including a variety of volatile memories, non-volatile memories, or a combination thereof. For example, in some embodiments, one or more of the memory circuits or portions thereof may include NAND flash memory cores. In other embodiments, one or more of the memory circuits or portions thereof may include NOR flash memory cores, Static Random Access Memory (SRAM) cores, Dynamic Random Access Memory (DRAM) cores, Magnetoresistive Random Access Memory (MRAM) cores, Phase Change Memory (PCM) cores, Resistive Random Access Memory (ReRAM) cores, 3D XPoint memory cores, ferroelectric random-access memory (FeRAM) cores, and other types of memory cores that are suitable for use within the computer-readable medium 410. In some embodiments, one or more of the memory circuits or portions thereof may be configured as other types of storage class memory (“SCM”). Generally speaking, the memory circuits may include any of a variety of Random Access Memory (RAM), Read-Only Memory (ROM), Programmable ROM (PROM), Erasable PROM (EPROM), Electrically EPROM (EEPROM), hard disk drives, flash drives, memory tapes, cloud memory, or any combination of primary and/or secondary memory that is suitable for performing the operations described herein.

The computer-readable medium 410 may also be configured to store data 450. The data 450 may include CE values for one or more microelectrochemical cells, current density values from one or more microelectrochemical cells, applied potential data for one or more microelectrochemical cells, transient cyclic voltammetry data for one or more microelectrochemical cells, current exchange density (j₀) values for one or more microelectrochemical cells, linear equations that model a function of j₀ vs CE data for a set of microelectrochemical cells, or estimated CE values for one or more microelectrochemical cells.

It is to be understood that only some components of the computing system 400 are shown and described in FIG. 4. However, the computing system 400 may include other components such as various batteries and power sources, networking interfaces, routers, switches, external memory systems, controllers, etc. Generally speaking, the computing system 400 may include any of a variety of hardware, software, and/or firmware components that are needed or considered desirable in performing the functions described herein. Similarly, the host device 405, the input devices 415, the output devices 420, and the computer-readable medium 410, including the memory controller 440, may include hardware, software, and/or firmware components that are considered necessary or desirable in performing the functions described herein.

### EXAMPLES

### Example 1: This Example Illustrates the Use of Rapid Transient CV Measurements for the Predication of CEs for Microelectrochemical Cells

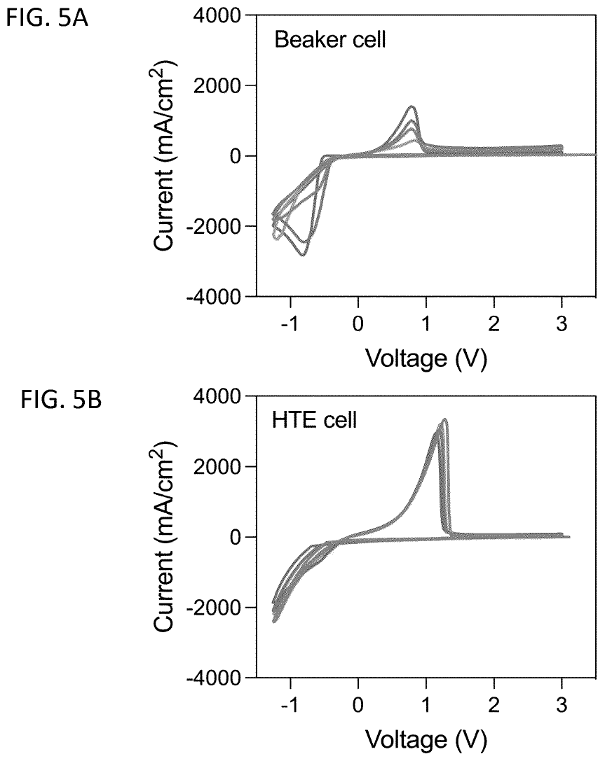

As a proof-of-concept, a microelectrochemical cell array comprising 24 independent, parallel three-electrode microelectrochemical cells was fabricated; each cell was equipped with a UME as its working electrode. Three current collectors were patterned using photolithography and metal evaporation, and then Na metal was transferred onto the current collectors of counter and reference electrodes to form a three-electrode cell. The array was paired with liquid handling robots and a multiplexer to automatically dispense electrolyte onto microelectrochemical cells, conduct transient CV measurements, process the data, and calculate exchange current densities, jₒ. An in-house python program was written to extract the j₀ values using a linear fit to the equilibrium portions of the CV curves—in this case, within a window from −20 mV to 20 mV around the equilibrium potential. The transient CV data for a cell containing 20 μL 1M NaPF₆ in FEC as an electrolyte solution showed excellent data consistency and very low standard deviations for jₒ (FIG. 5B).

For purposes of comparison, CV curves for an analogous electrochemical beaker cell are shown in FIG. 5A. In the beaker cell setup, the counter and reference electrodes had surface areas of at least 1 cm². All three electrodes were positioned as close as possible to minimize solution resistance. To fully immerse the electrodes, approximately 2-3 mL of electrolyte was added to a 6 mL beaker cell.

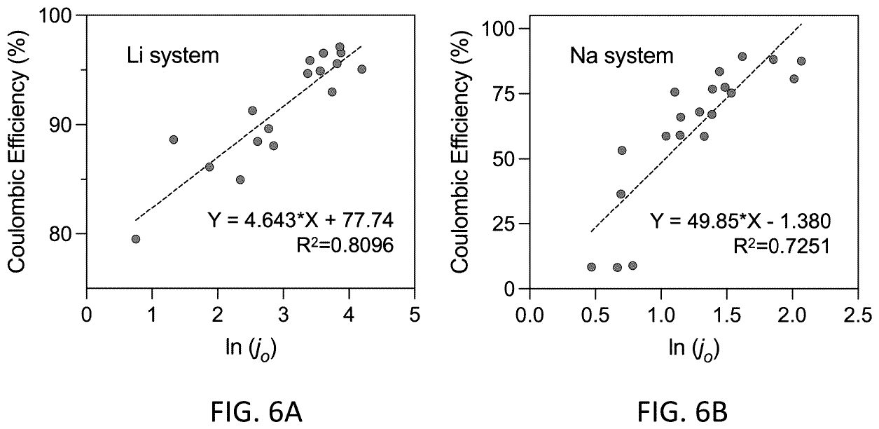

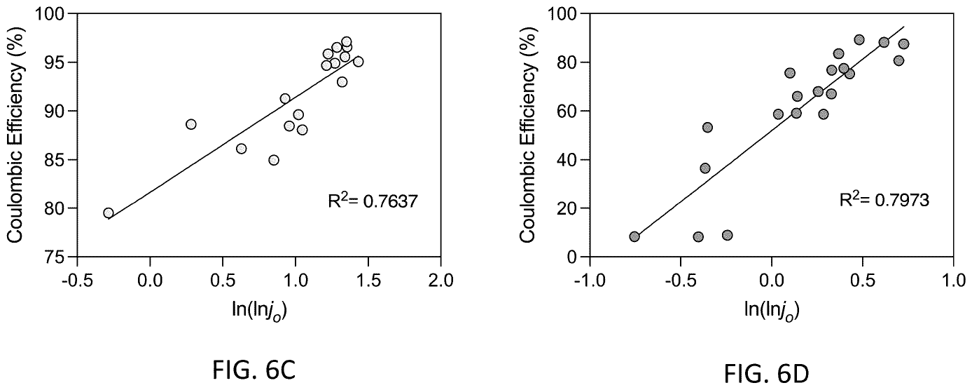

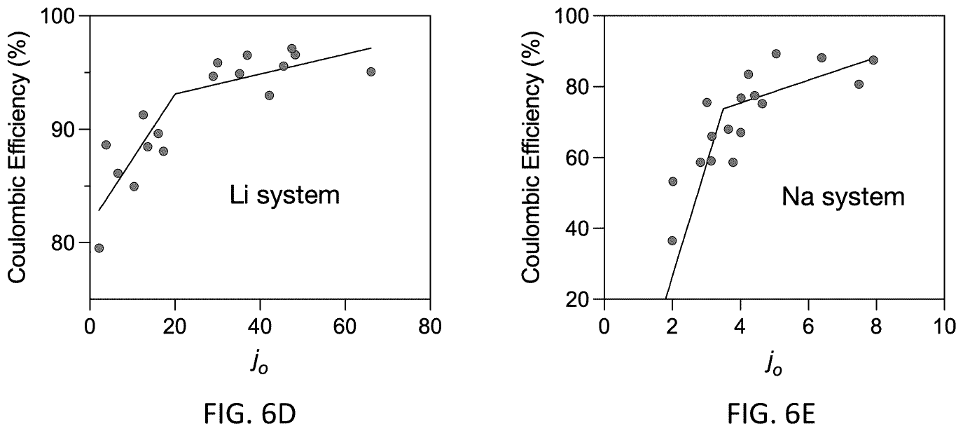

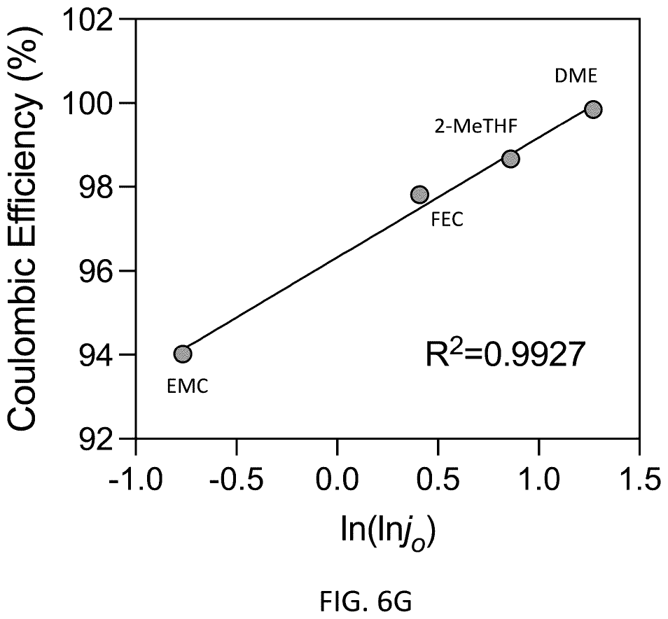

Using microelectrochemical cell arrays, a relationship between CE and jₒ was established by using a linear regression to jₒ versus CE data to generate a linear equation for the microelectrochemical cells (FIGS. 6A and 6B).

The CE data in FIG. 6A was extracted from Boyle, David T., et al. “Correlating kinetics to cyclability reveals thermodynamic origin of lithium anode morphology in liquid electrolytes.” Journal of the American Chemical Society 144.45 (2022): 20717-20725. A plot of that data versus ln(j₀) was then fitted to produce the line shown in the figure via a simple linear regression. Per Boyle et al. (2022), the CE values were calculated based on the first cycles of metal deposition and stripping. The CE values in FIG. 6B were obtained using the well-known Aurbach method, and the CE was an average CE based on 10 cycles.

The data in FIG. 6B were obtained using electrolyte solutions containing 1M NaPF₆ in different solvent systems, as shown in the table below.

Solvent compositions

FEC
EC
DMC
1:1 FEC:EC
1:1 FEC:DMC
1:1 EC:DMC
67:33 FEC:EC
67:33 FEC:DMC
33:67 FEC:EC
33:67 FEC:DMC
67:33 EC:DMC
33:67 EC:DMC
75:13:13 FEC:EC:DMC
13:75:13 FEC:EC:DMC
13:13:75 FEC:EC:DMC
33:33:33 FEC:EC:DMC
50:17:33 FEC:EC:DMC
50:33:17 FEC:EC:DMC
17:50:33 FEC:EC:DMC
33:50:17 FEC:EC:DMC
17:33:50 FEC:EC:DMC
33:17:50 FEC:EC:DMC
FEC: Fluoroethylene carbonate;
EC: Ethyl carbonate;
DMC: Dimethyl carbonate

A plot of the CE data in FIGS. 6A and 6B versus ln(ln j₀) was also analyzed for a simple linear regression fit and the results are shown in FIGS. 6C and 6D. As shown by the linear fits in those figures, this relationship is also well modeled by a linear fit.

Additionally, a plot of the CE data in FIGS. 6A and 6B versus j₀ (i.e., the trivial function j₀=j₀) was analyzed for a piecewise linear regression fit and the results are shown in FIGS. 6E and 6F. As shown by the linear fits in those figures, this relationship is well modeled by a piecewise linear fit.

Next, four different electrolyte solutions were tested in microelectrochemical cells: 1 M NaPF₆ in: EMC; FEC; 2-MeTHF (2-MeTHF: 2-methyltetrahydrofuran); and DME). In each microelectrochemical cell, a Cu-based UME was used as a working electrode and Na was used as both counter and reference electrodes. A volume of 5 μL electrolyte solution was used in each microelectrochemical cell and the voltage was scanned between 2.5V to −1.2V with a scan rate of 20-30 V/s. The data was analyzed in the same way as data collected from beaker cells. As shown in FIG. 6G, a linear regression fit to the ln (ln j₀) versus CE data for the microelectrochemical cells also revealed a linear correlation.

### Example 2: This Example Describes a Method for Calculating Exchange Current Density for a Microelectrochemical Cell (MC) from a Transient Cyclic Voltammogram. For the Purposes of this Disclosure, the Method Described in this Example is Denoted the “Kinetically Controlled Exchange Current Calculation.”

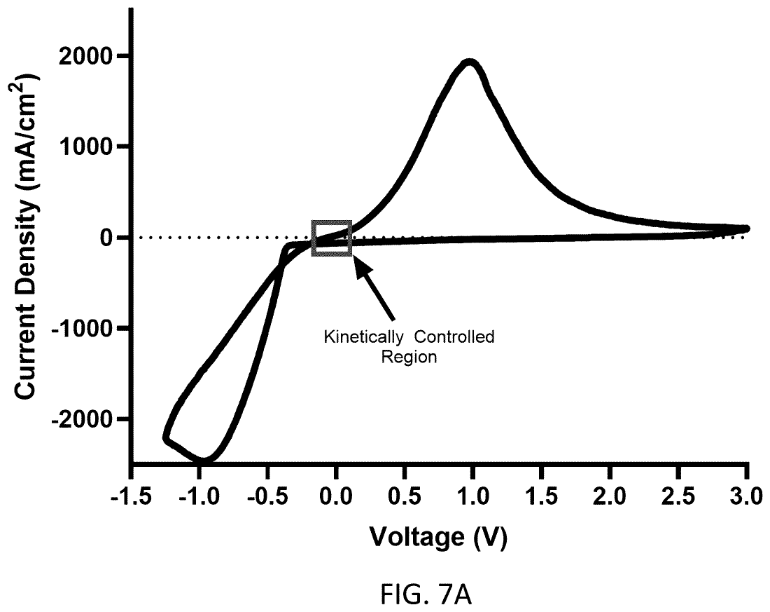

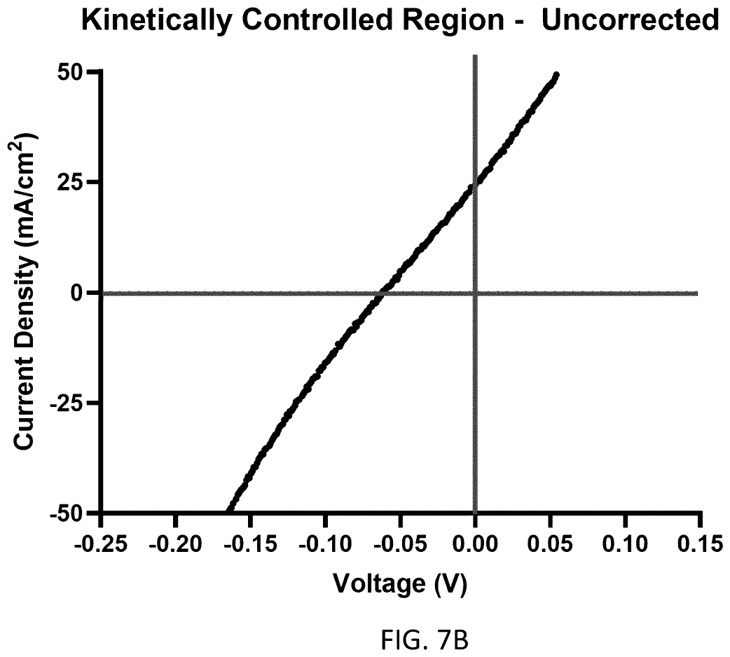

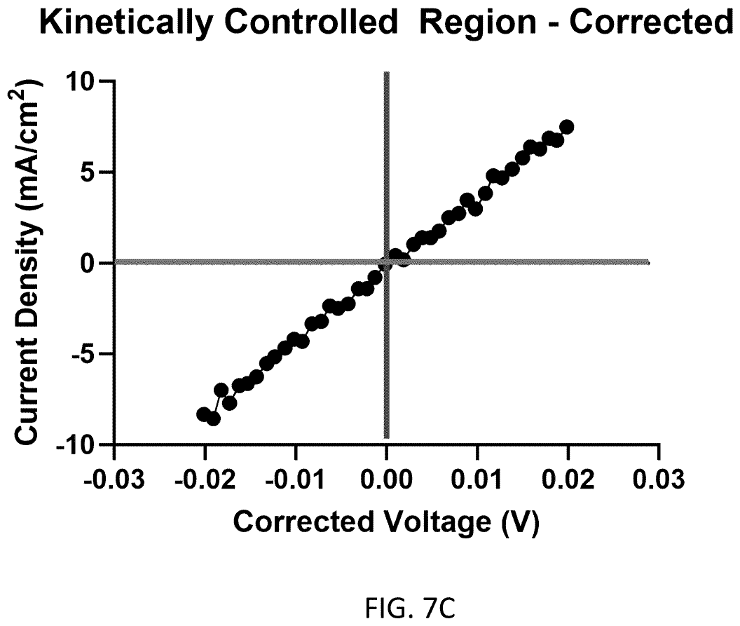

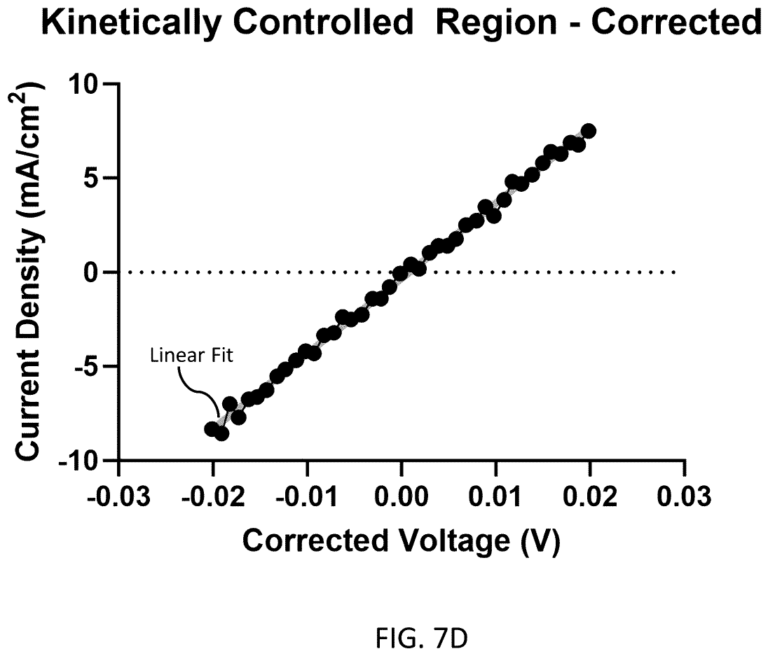

The exchange current density, j₀, for an MC can be calculated from the transient cyclic voltammograms by fitting the linear portion of the CV curves (i.e., the kinetically controlled region) near the equilibrium potential for the cell's charge and discharge cycles (e.g., metal plating and stripping cycles) (FIG. 7A). The transient voltammogram is first corrected for any iR drop associated with uncompensated resistance in the cell, and the equilibrium voltage is fixed such that the point at which the current changes from negative to positive (i.e., cathodic to anodic) is adjusted to occur at zero volts versus the redox couple for the metal (FIGS. 7B and 7C). After correcting the equilibrium voltage, a small voltage window is chosen over which to fit a linear model, for example, about +/−50 mV or smaller (e.g., +/−20 mV or smaller); see box in FIG. 7A). The size of the window is selected to achieve a good linear fit with a coefficient to determination (R²) of at least 0.9. However, linear fits with a coefficient to determination (R²) of at least 0.95 or at least 0.99 may be preferable.

At low overpotentials, the Butler-Volmer equation reduces to a simple linear form where the current density is proportional to the overpotential, with the slope containing the exchange current density and other fixed constants (FIG. 7C).

Low-overpotential Butler Volmer approximation:

$$j = {j}_{0} * \frac{z F}{R T} η .$$

For the illustrative example of FIGS. 7A-7D, the linear regression gave a slope of 399. Taking z=1, and T=298 K:

$${j}_{0} = 10.25 mA / {cm}^{2} .$$

### Example 3: This Example Illustrates Methods for Forming an Array of Microelectrochemical Cells on a Dielectric Substrate

A 100 mm diameter dielectric wafer, such as a quartz wafer polished on both sides, 500 μm thick with a single bevel, was spin coated with a photoresist, such as a APOL-LO 3202 photoresist. The resist was soft-baked (e.g., for a duration of 60 seconds at 110° C.). Through a photomask, the wafer was exposed to UV light of a specified dose according to the machine to form an array pattern in the photoresist. Alternatively, a laser writer can be used to transfer the desired array pattern to the photoresist. The wafer was then baked again (e.g., for a duration of 60 seconds at 110° C.). The wafer was then submerged in a developer, such as an AZ MIF 300 developer, for a period of development (e.g., 45 seconds), then rinsed thoroughly with deionized (DI) water, and dried with N₂(g) or compressed air. A plasma descum can be used to remove any residual photoresist or debris from the wafer (gentle oxygen plasma). A metal evaporator or sputterer may be used for metal deposition, which can begin with the deposition of a thin (e.g., 5-10 nm-thick) chromium adhesion layer. A thicker layer (e.g., ~100 nm) of the desired metal (e.g., tungsten, copper, aluminum, etc) was then deposited. The wafer was then submerged in a hot 1165 microposit remover, and sonicated, if necessary, to remove all photoresist. The wafer was then thoroughly rinsed with DI water and baked at 110° C. for 5 minutes to drive off any moisture.

A dielectric layer was then deposited. Two illustrative approaches for the deposition of the dielectric material of this layer are as follows: a thin layer (e.g., 150 nm) of dielectric material (e.g., SiO₂) was deposited using, for example, plasma-enhanced chemical vapor deposition (PECVD), followed by spin coating with a photoresist, such as an AZ 1505 photoresist. The photoresist was then soft-baked (e.g., for 90 seconds at 110° C.) and exposed with, for example, a laser writer or on an aligner with a custom mask. The wafer was then submerged in a developer, such as an AZ MIF 300 developer, for a period of development (e.g., 60 seconds), followed by a thorough rinse with DI water and drying with N₂(g) or compressed air. Optionally, a plasma descum can be performed to remove any residual photoresist or debris. The wafer was then etched in a reactive ion etcher with a CF₄ plasma to remove SiO₂ from the electrode areas. Finally, the remaining photoresist was removed by submerging the wafer in hot 1165 microposit remover.

Alternatively, a photoresist, such as an APOL-LO 3202 photoresist, can be spin-coated on the wafer and soft-baked (e.g., for 60 seconds at 110° C.). The wafer was then exposed using, for example, a laser writer or on an aligner with a custom mask. The wafer was then baked again, followed by submersion in a developer, such as an AZ MIF 300 developer, for a development period (e.g., for 45 seconds), then rinsed thoroughly with DI water and dried with N₂(g) or compressed air. Optionally, a plasma descum can be performed to remove any residual photoresist or debris. A dielectric evaporator can be used to evaporate a thin (e.g., 150 nm) layer of SiO₂. The wafer can then be submerged in hot 1165 microposit remover to remove the resist from the masked electrode areas.

Arrays of the microelectrochemical cells made by these and other methods can be integrated with microfluidic fixtures to allow electrolyte flow and to facilitate efficient cleaning, enabling repeated device reuse.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. A method for evaluating liquid electrolytes in a microelectrochemical cell array comprising a plurality of sample microelectrochemical cells, each sample microelectrochemical cell comprising:
a well containing a sample liquid electrolyte solution, wherein the sample liquid electrolyte solutions are different in different sample microelectrochemical cells, and further wherein the sample liquid electrolyte solution has a volume of no greater than 200 μL;
an ultramicro-working electrode in the sample liquid electrolyte solution; and
a counter electrode in the sample liquid electrolyte solution,
the method comprising:
generating one or more transient cyclic voltammograms for each sample microelectrochemical cell under conditions in which electrochemical reactions at the ultramicro-working electrode are kinetically controlled;
calculating an exchange current density (j₀) for each sample microelectrochemical cell based on the one or more transient cyclic voltammograms for said sample microelectrochemical cell;
providing a linear regression model for a plot of j₀ function values obtained from a set of standard microelectrochemical cells versus Coulombic efficiency (CE) values obtained from a set of corresponding standard electrochemical cells; and
estimating the CE for each sample microelectrochemical cell based on a comparison of its calculated exchange current density with the linear regression model.

2. The method of claim 1, wherein the wells, the ultramicro-working electrodes, and the counter electrodes are integrated into a dielectric array substrate.

3. The method of claim 1, wherein each of the sample microelectrochemical cells further comprises a reference electrode in the sample liquid electrolyte solution.

4. The method of claim 1, wherein the sample liquid electrolyte solution has a volume of no greater than 100 μL.

5. The method of claim 1, wherein the sample liquid electrolyte solution has a volume of no greater than 20 μL.

6. The method of claim 1, wherein the ultramicro-working electrode has at least one dimension that is smaller than 25 μm.

7. The method of claim 1, wherein calculating an exchange current density (j₀) for each sample microelectrochemical cell comprises generating a linear fit to a linear portion of the one or more transient cyclic voltammograms.

8. The method of claim 1, wherein the j₀ function is ln(j₀).

9. The method of claim 1, wherein the j₀ function is ln(ln j₀).

10. The method of claim 1, wherein the j₀ function is j₀.

11. The method of claim 1, wherein a Kinetically Controlled Exchange Current Calculation is used to calculate the exchange current density (j₀) for each sample microelectrochemical cell based on the one or more transient cyclic voltammograms for said sample microelectrochemical cell.

12. The method of claim 1, wherein the linear regression model is a simple linear regression model with a coefficient of determination (R²) of 0.7 or higher.

13. The method of claim 12, wherein the j₀ function is ln(j₀) or ln(ln j₀).

14. The method of claim 1, wherein the linear regression model is a piecewise linear regression model and each linear segment of the piecewise linear regression model has a coefficient of determination (R²) of 0.7 or higher.

15. The method of claim 14, wherein the j₀ function is j₀.

16. A system for evaluating liquid electrolytes comprising:
a microelectrochemical cell array comprising a plurality of microelectrochemical cells, each microelectrochemical cell comprising:
a well for containing a sample liquid electrolyte solution, the well configured to hold sample liquid electrolyte solution having a volume of no greater than 200 μL;
an ultramicro-working electrode in the well; and
a counter electrode in the well;
one or more potentiostats connected to the ultramicro-working electrode in each microelectrochemical cell; and
a computing system comprising:
a memory having computer-readable instructions stored thereon; and
a processor that executes the computer-readable instructions to:
receive a linear regression model for a plot of j₀ function values obtained from a set of standard microelectrochemical cells versus Coulombic efficiency (CE) values obtained from a set of corresponding standard electrochemical cells;
receive applied potential versus current density data generated by the one or more potentiostats;
generate transient cyclic voltammograms for the plurality of microelectrochemical cells based on the applied potential versus current density data;
calculate exchange current density (j₀) values for the plurality of microelectrochemical cells from the transient cyclic voltammograms; and
estimate a CE for each of the one or more microelectrochemical cells based on a comparison of its calculated exchange current density value with the linear regression model.

17. The system of claim 16, further comprising a reference electrode in each well.

18. The system of claim 16, further comprising a multiplexer connected to the one or more potentiostats.

19. The system of claim 16, wherein the j₀ function is ln(j₀) or ln(ln j₀).

20. The system of claim 16, wherein the j₀ function is j₀.
